(19) United States
(12) Patent Application Publication
(10) Pub. No.: US 2010/0257171 A1
(43) Pub. Date: Oct. 7, 2010

(54) TECHNIQUES FOR CATEGORIZING SEARCH QUERIES

(75) Inventor: Ajay Shekhawat, San Francisco, CA (US)

Correspondence Address: Weaver Austin Villeneuve & Sampson - Yahoo!, P.O. BOX 70250, OAKLAND, CA, 94612-0250, US

(73) Assignee: Yahoo! Inc., Sunnyvale, CA (US)

(21) Appl. No.: 12/418,112

(22) Filed: Apr. 3, 2009

(51) Int. Cl. G06F 17/30; G06Q 30/00

(52) U.S. Cl. 707/738; 707/E17.014; 707/E17.032; 707/771

(57) ABSTRACT

Methods and apparatus are described to automatically categorize search queries. According to specific embodiments, this is accomplished by comparing search results responsive to an uncategorized query with search results responsive to queries in a categorized set. Search results from the categorized set are assigned categories and weights corresponding to the queries which produced them. Matches with search results for the uncategorized query are located in this data, and the corresponding categories and weights associated with the uncategorized query. These techniques can be applied to improve the relevancy of organic search results, sponsored search results, advertisements, marketing communications, news articles, and other types of content on both the provider's websites and other websites.

### BACKGROUND OF THE INVENTION

The present invention relates to search technology and related services such as those provided on the World Wide Web and, more specifically to techniques for categorizing search queries entered by users in search engines.

Understanding a user's intent behind a given search query is the key to providing search results, both organic and sponsored, that meet the needs of both users and advertisers. The ability to classify a search query into one of a given set of categories is extremely useful in understanding the user's intent. However, assigning a user's query to a category can be a very challenging task. In many cases the category may be obvious. For example, the query “Buffalo Bills,” may readily be assigned to the “Sports” category.

On the other hand, in many other cases, particularly in cases involving so-called “tail queries,” i.e., rare or unusual queries, the task is very hard. For example, what would the category be for “nickel defense” or “dime package?” In these cases, the relevant category is still Sports, but without the proper domain knowledge, categorization is not as straightforward.

For many years, researchers have been attempting to develop automated ways to assign categories to queries. Unfortunately these efforts have not met with consistent success. Currently, the most effective technique for categorizing queries is a manual approach in which humans assign the categories. However, with hundreds of millions of queries coming into the larger search engines on a daily basis, such a manual approach simply isn't scalable.

### SUMMARY OF THE INVENTION

According to the present invention, automated techniques for categorizing search queries are presented. Embodiments for methods, systems, and computer program products to categorize search queries are provided. The process is seeded with an initial set of search queries associated with known categories. Search results responsive to these queries are obtained. Each search result is assigned a set of categories based on the categories of queries which produced the search result. Each category in a set is assigned a weight based on a frequency with which the corresponding search result appeared in response to the queries. An uncategorized query is then categorized.using this data. Search results responsive to the uncategorized query are obtained. Where these search results appear in the categorized data, the corresponding categories and weights are used to categorize the uncategorized query.

A further understanding of the nature and advantages of the present invention may be realized by reference to the remaining portions of the specification and the drawings.

### BRIEF DESCRIPTION OF THE DRAWINGS

FIG. 1 is a representation of a set of categorized search queries for use with various embodiments of the invention.

FIG. 2 illustrates categorization of an uncategorized search query in accordance with a particular embodiment of the invention.

FIG. 3 is a flowchart illustrating categorization of an uncategorized search query in accordance with a particular embodiment of the invention.

FIG. 4 is a simplified diagram of a computing environment in which embodiments of the present invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Categorizing search queries is an effective way to provide more relevant responses. Once a query is assigned to one or more categories, relevant information related to those categories becomes available. However, categorization poses a difficult problem for automated methods. The most accurate categorization is performed manually by people. Search engines dealing with millions of unique and constantly changing queries can not rely on such a time-consuming and expensive method.

The present invention relates to automatically categorizing search queries using a set of categorized queries. Queries in the categorized set are used to generate search results. Each search result is then assigned categories and weights based on the categorized queries which produced it. An uncategorized query can then be categorized from this data. Search results responsive to the uncategorized query are obtained, the categories and weights associated with each search result are retrieved, and categories for the uncategorized query chosen based on these values. The categorization of search queries in accordance with embodiments of the invention can be used to improve the relevance of many types of content including, for example, organic search results, sponsored search results, advertising content, news articles, and marketing communications, among others. Techniques enabled by the present invention can be further extended to associate categories with particular users or websites.

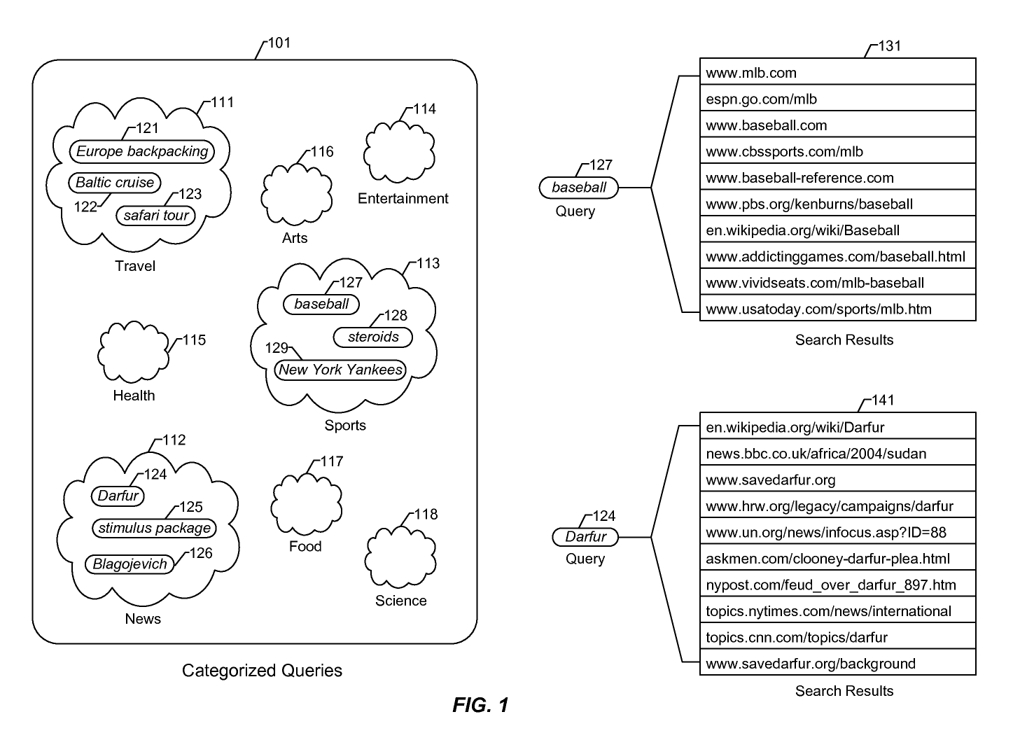

FIG. 1 is a representation of a set of categorized search queries which will be used to illustrate a particular embodiment of the invention. In this simplified example, a set of search queries 101 has been arranged into (e.g., tagged with) categories 111-118. Each category includes search queries on a related topic, such as, for example, Travel 111, News 112, or Sports 113. Some example search queries 121-129 within these categories are shown. Queries like “Europe backpacking” 121, “Baltic cruise” 122, and “safari tour” 123 are assigned to the Travel category. The choice of categories and assignment of queries to categories can be performed in a limitless number of ways as discussed herein. As will be understood, in the various embodiments described below, the queries, associated categories, and various other data discussed may be stored as various types of data structures in one or more databases resident on one or more data storage devices.

Each search query is associated with search results responsive to the query. Results for two such queries are depicted. The query “baseball” 127 is associated with search results 131 and the query “Darfur” 124 is associated with search results 141. In FIG. 1, the search results are represented as a list of URLs. As shown the search results may correspond to various different units of information such as, for example, domains, web sites, individual web pages, portions of pages, documents in various formats, etc. In some embodiments, these results are obtained by querying a search engine or search database with the given query term. In other embodiments, the results may include a history of results obtained from logs of responses to past queries including or corresponding to the query term. Those skilled in the art will appreciate other methods as well. In some embodiments, search results may be obtained from a data store containing results served for the queries in the past. In other embodiments, search results can be generated on the fly by querying a search engine.

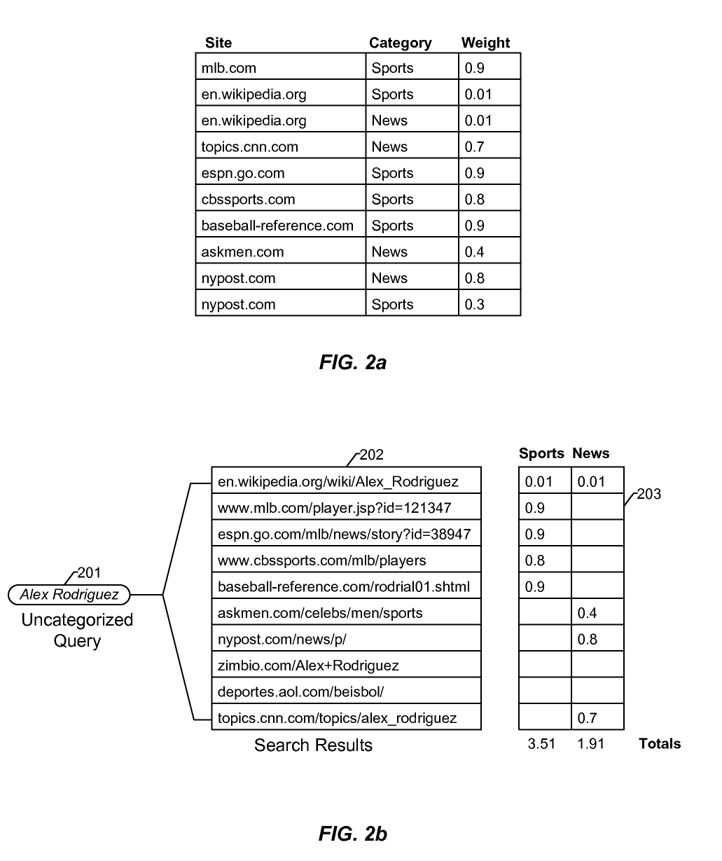

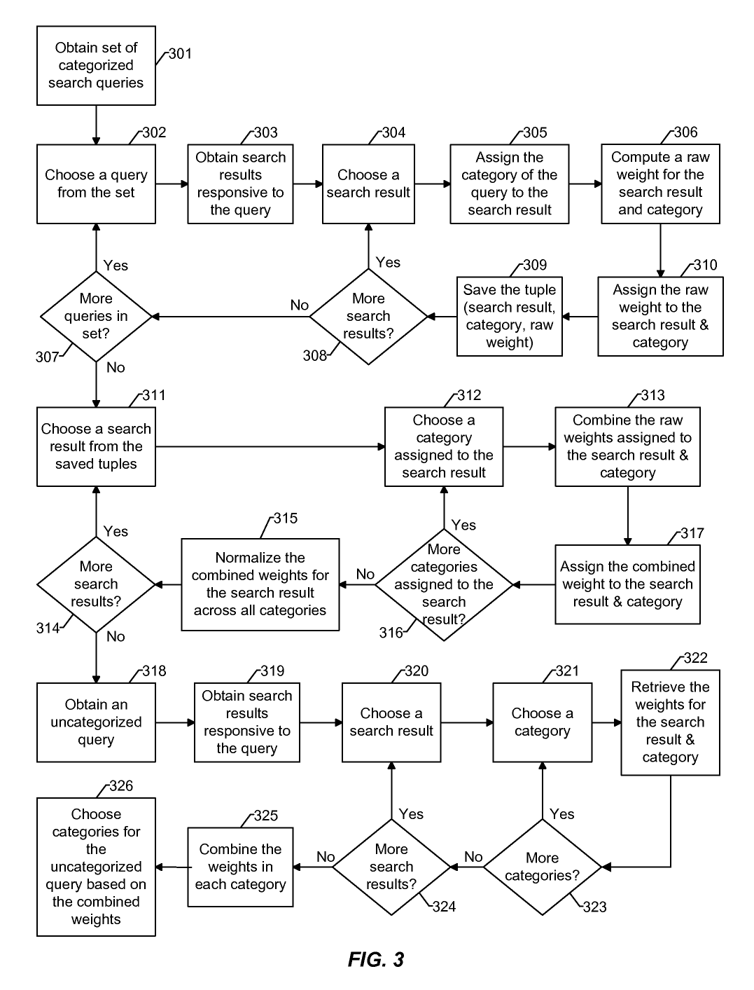

FIGS. 2 and 3 illustrate categorization of an uncategorized search query in accordance with a particular embodiment of the invention. FIG. 2a depicts a table of search results with assigned categories and weights. As described below, this table is constructed from a set of categorized queries and search results responsive to those queries. In this example, the table contains entries representing a portion of the elements in FIG. 1. For each search query (302) in the categorized set (301), a list of search results responsive to that query is obtained (303). As mentioned above, these results may be obtained from search logs, or from application of the query to a search engine.

Each search result (304) is assigned the category of the query to which it was responsive (305). For example, the query “baseball” in FIG. 1 produced “www.mlb.com” as a search result. Since “baseball” falls within the category “Sports” in categorized query set 101, “mlb.com” is assigned the category “Sports” in FIG. 2a. For this example, only the hostname portion of a URL is considered. However, it should be understood that embodiments are contemplated in which more and less granular approaches are employed.

Search results can be assigned multiple categories. This occurs when a search result appears in response to multiple queries in different categories. For example, the URL “en.wikipedia.org/wiki/Baseball” appears as a search result for the query “baseball” 127 in FIG. 1 and the URL “en.wikipedia.org/wiki/Darfur” appears as a result to the query “Darfur” 124. Considering only the hostname portion of these URLs, both search results reduce to “en.wikipedia.org”. This search result is assigned to both the “Sports” category corresponding to the query “baseball” and the “News” category corresponding to the query “Darfur”. This is depicted by the two entries for “en.wikipedia.org” in the second and third rows of FIG. 2a.

Each search result is assigned a weight that is reflective of how relevant a search result is likely to be in determining the category of a new query. Weights can reflect how frequently a search result is returned for a particular query. Results that appear often are likely more stable and more relevant than those which do not. Weights can also indicate which sites are more focused on a particular category. General sites like Wikipedia cover many topics and tend to be assigned large numbers of categories. As a result, general sites are typically less useful for categorizing an uncategorized query. Weights for a particular site can be normalized across all the categories that site encompasses, yielding lower weights for general interest sites. Other measures of relevance can also be incorporated into the weight.

The third column of FIG. 2a shows weights assigned to selected search results and categories. One example embodiment for calculating the weight of a selected search result in a given category is as follows. In this example, search results responsive to a query include a history of responses to the query over time. Each response includes a list of search results returned a particular time the query was made. A raw weight is computed by counting the number of times the selected search result appears in the history and dividing by the total number of responses in the history. This raw weight is assigned to the search result and category (310), creating a tuple (search result, category, raw weight). This tuple is saved (309) while the remaining search results (308) and queries (307) are processed.

For example, consider the site mlb.com and the category Sports in FIG. 2a. Referring to FIG. 1, the query “baseball” 127 is chosen from the category Sports 113. Then a history of search results for “baseball” over time is obtained. This history includes multiple instances of search results, each instance containing search results for the query “baseball” as depicted by list 131. Suppose the history contains 50 such instances, and the search result “mlb.com” appears in 45 of those lists. The raw weight for mlb.com in the category Sports would be 45/50=0.9 in one embodiment.

After the categorized set of queries is processed, the raw weights for each search result (311) and category (312) combination are combined into a single weight (313). This can be done in many ways. In one embodiment, the raw weights are summed, giving more weight to search results which appear for many queries in a given category. In other embodiments, the search results could be averaged or a subset of the raw weights selected, such as a minimum or maximum value. A wide variety of other techniques for generating a single weight with reference to these raw weights will be appreciated by those of skill in the art and are within the scope of the invention. One way is to take the maximum weight that has been assigned to the search result in each category. Another way is to take the average of the weights assigned to that search result. Yet another way is to take a weighted average of the raw weights, where the weighted value of each raw weight is proportional to the frequency of the query that yielded the search result. Other techniques will be apparent to those of skill in the art. Such methods may be used separately or combined according to various embodiments.

Continuing the previous example, suppose mlb.com appears in response to two queries within the Sports category, “baseball” and “New York Yankees”. This would produce two raw weight tuples for mlb.com: the previously discussed (mlb.com, Sports, 0.9) corresponding to “baseball”, and another tuple (mlb.com, Sports, 0.75) corresponding to “New York Yankees”. These tuples are combined into a single weight for the combination mlb.com and Sports. Under the “maximum weight” scenario above, mlb.com would be assigned a weight of 0.9. Alternately, under the “average” scenario, it would be assigned 0.825. Further, if we assume (for the sake of this example) that the query “baseball” was represented 50 times in the history whereas “New York Yankees” occurred just once, then under the weighted average scheme “mlb.com” would get the weighted average (50*0.9+1*0.75)/51, or about 0.897. Persons skilled in the art can derive many other weighted combination schemes. FIG. 2a illustrates the maximum weight method, assigning the weight 0.9 to “mlb.com” in the category Sports.

The weights may then be normalized for the number of categories in which the given search result appears (315). Normalization gives general sites which span many categories less emphasis. One way to accomplish this is by dividing each weight by the number of categories in which the given search result appears. The normalized weight is stored with the given search result and category. For example, suppose we have the tuples (en.wikipedia.org, Sports, 0.5) and (en.wikipedia.org, News, 0.5). Further suppose that en.wikipedia.org appears as a search result in 50 different categories. Then the weight for each en.wikipedia.org tuple would be divided by 50, producing the normalized tuples (en.wikipedia.org, Sports, 0.01) and (en.wikipedia.org, News, 0.01) shown in FIG. 2a. Such a result makes sense in that Wikipedia is a general site that is not dominated by content in any particular category.

The foregoing description illustrates a particular approach to assigning weights and categories to search results using a set of categorized queries. It should be noted, however, that a wider variety of approaches are contemplated to be within the scope of the present invention. For example, the order in which various operations are performed may be altered while achieving the same result. Certain operations can be parallelized or performed in a different order. For example, the (search result, category, raw weight) tuples may be combined in a form of “running total” as they are generated rather saving multiple tuples for each (search result, category) combination. Those skilled in the art will appreciate a wide range of possibilities for modifying the described process.

Repeating the category and weight assigning process for each search result of each query in the categorized set yields tuples (search result, category, weight) such as illustrated in FIG. 2a. In some embodiments, this process may be performed every time an uncategorized query needs to be categorized. Other embodiments may store the tuple data for efficiency. These embodiments may periodically update or regenerate the tuples to reflect queries being added to or removed from the categorized set or query histories being updated.

FIG. 2b and the remainder of FIG. 3 illustrate categorizing an uncategorized query using the (search result, category, weight) tuples. In some embodiments, the uncategorized query originates from an end user on a user device submitting a query to a search engine operating on or in conjunction with one or more servers. Categorization may occur in real-time on the server handling the query, or queries may be stored for batch processing by the same or another server, according to various embodiments. Using an uncategorized query, e.g., “Alex Rodriguez” 201 in FIG. 2b, search results 202 responsive to the uncategorized query are obtained (319). Various embodiments may obtain these search results in different ways. For example, they may be taken from a history of responses to the query if available, such as in a database of results served to queries. One response (i.e., one set of search results) from the history may be chosen, such as the most recent response. Alternately, results can be taken from multiple responses in the history of the query. The most frequent results over time from the history may be used. Results with the highest weighted average may be selected for some averaging function. A wide variety of functions for combining, amalgamating, or selecting search results from the history may be employed without departing from the scope of the invention. In another embodiment, search results for the uncategorized query may be obtained in real-time by submitting the uncategorized query to a search engine.

The categories (321) and weights associated with each search result responsive to the uncategorized query (320) are retrieved (322). This may involve retrieving tuples for each search result in a database or data storage device or from a data structure in memory, according to various embodiments. For example, the search result “en.wikpedia.org/Alex_Rodriguez” appears in search results 202. Tuples for en.wikipedia.org are retrieved, since this example only considers the hostname portion of the URL in a search result. Referring to FIG. 2a, en.wikipedia.org has two tuples: one for category Sports with weight of 0.01, and another for category News with weight 0.01. The search result en.wikpedia.org/Alex_Rodriguez in FIG. 2b is assigned these categories and weights in 203. The site www.mlb.com/player.jsp?id=121347 is assigned the weight 0.9 for the category Sports, corresponding to the tuple (mlb.com, Sports, 0.9) in FIG. 2a. The site mlb.com has no weight for the category News since mlb.com does not appear as a search result for any of the News queries in the categorized set in this example.

Continuing in this manner, categories and weights 203 for each search result responsive to the uncategorized query (324) are retrieved using the tuple data generated from the categorized set. Each category is then assigned a total weight based on the weights of some or all of the search results in that category (325). Total weight can be calculated in a variety of ways, including sums, averages, threshold functions, and other methods known in the art. The total weights in the example illustrated in FIG. 2b are the sums of the individual weights for that category, represented by the columns in 203. This yields a total weight of 3.51 for the category Sports and 1.91 for the category News. Based on these weights, categories are associated with the uncategorized query (326). In one embodiment, the highest weighted category may be selected, associating the query “Alex Rodriguez” with the category Sports. Other embodiments may associate the query with multiple categories by, for example, selecting some number (e.g., 2 or 3) of the top weighted categories or all categories above a certain threshold weight.

This example demonstrates one advantage of some embodiments of the present invention over less accurate categorization methods which rely on the analysis of the query words, and therefore have less information to work with. For example, the query “Alex Rodriguez” would be recognized as consisting of two names: Alex and Rodriguez. A word analysis method might categorize the query as belonging to a generic category such as People. However, by using search results the present method can detect that the query “Alex Rodriguez” is related to many sites dealing with baseball. This leads to a more relevant categorization such as Sports. So, while the word analysis method might display less relevant ads related to the People category, e.g., person locator services, the present method could be leveraged to show more relevant ads such as baseball jerseys or Yankees tickets.

Certain embodiments have the advantage of allowing categorization in real-time. The set of tuples generated from the categorized query set are relatively small and can be stored for later use. The category and weight data for each search result are small enough to store in association with search results in the search engine databases, according to some embodiments. When a new search query is received by the search engine, it first retrieves the search results responsive to that query. Associating categories with a new search query only requires a few database lookups to retrieve the categories and weights assigned to the search results. If the categories and weights are linked to each search result in the search engine database, extra database lookups may be eliminated. From there, calculations to combine the weights and select categories for the new query are fairly minimal. Thus, these operations may be performed in real-time, e.g., between the time an end user clicks a Search button in his browser and the browser displays results, without introducing significant delay. According to other embodiments, uncategorized queries can be processed in batch mode offline, including as regular batch updates or as part of scheduled daily maintenance routines.

Embodiments of the present invention can be used in various contexts. In the following examples, the process for generating tuples (search result, category, weight) of the type illustrated in FIG. 2a from the categorized set of queries proceeds as in one of the aforementioned embodiments. These tuples can then used in various ways according to the context as described herein.

One example is improving organic search results, e.g. the unpaid search results that a search engine returns as most relevant to a query. An incoming query can be associated with a set of categories and weights using an embodiment of the invention. These categories and weights can be used to tailor the organic search results returned to a user. For example, suppose the query “Brad Pitt” is associated with the categories and weights (Movies, 0.5), (Celebrities, 0.3) and (News, 0.2). Organic search results for “Brad Pitt” may be reordered using this data. For example, documents corresponding to the Movies category may be emphasized, followed by results corresponding to Celebrities and then News. As another example, categories and weights can be used to alter which organic search results are returned. Suppose that 60% of the organic search results for “Brad Pitt” are documents related to the News category, while only 20% are related to Movies. This might occur if Brad Pitt has been in the news a lot recently, leading to many recent news queries, while historically he is more strongly associated with movie sites. Or it may happen if many of the organic search results are associated weakly with the News category, while a few organic search results are weighted heavily in Movies. Regardless of the circumstances, the composition of the organic search results can differ from the categories most associated with a query. The search engine provider may use embodiments of the invention to return more relevant results. Since “Brad Pitt” is more heavily weighted in the Movies category, the system may add or emphasize the search results related to Movies and/or deemphasize or remove some of the results related to News.

The categories may also be used to influence the presentation of the search results. Continuing with the “Brad Pitt” example above, currently most search engines present their results in a ranked list order, without context. If the categories of the individual search results were known, they could be grouped together into labeled sections such as (for the Brad Pitt example above) “Movies”, “Celebrities” and “News”, making it easier for the user to focus on his category of interest.

In another context, categorizing queries in accordance with an embodiment of the invention can be used to improve sponsored search results, i.e., search results associated with organic search results for which advertisers have paid for placement. The aforementioned “Alex Rodriguez” example demonstrates one possibility. Sponsored search results allow advertisers to target a specific audience. Advertisers bid on specific terms in user search queries that trigger display of their ad. For example, a sporting events ticket service can pay to show an advertisement every time a user searches for the terms “baseball”, “New York Yankees”, or “Yankee Stadium”. This increases ad effectiveness by showing ads to users likely to be interested in the offered product.

Such keyword bidding systems require advertisers to specifically enumerate the search query terms that trigger their ads. This presents a difficult task. Language is highly variable, with many synonyms and homonyms. Listing all the possible combinations of words referring to something like baseball is very challenging. Moreover, language constantly evolves. Advertiser would have to continuously monitor changing usage (including slang) to ensure they bid on the right terms. Ambiguity complicates the matter even further. If a user searches for “base”, does he mean a baseball base, a military base, a base camp, a chemical base, or something else entirely? Advertisers like the ticket service are forced to be either over-inclusive by paying to show their ads to users searching for unrelated kinds of bases, or under-inclusive by not showing ads to anyone searching for ambiguous terms.

Rather than bidding on individual terms, related search terms can be grouped together into categories. For example, the terms “baseball”, “New York Yankees”, and “Yankee Stadium” might be grouped together in the category “Sports”. A ticketing service could bid to show ads with queries that fall in the Sports category. These ads would be displayed for the specific terms mentioned above, as well as related terms like “home run” that fall within the Sports category, without requiring the advertiser to specifically enumerate search terms.

Similarly, categorization data can be used to select advertisements for placement on websites. Tuples (search result, category weight) corresponding to a particular website can be retrieved. For example, for the website mlb.com, tuples containing mlb.com in the search result portion are retrieved. Categories and weights are then read from these tuples and a set of categories and weights computed for the target website. In turn, these values may be used to select advertisements or other content for the website. For example, suppose the categorization process yields categories of (Sports, 0.7) and (News, 0.3) for a website xyz.com. Advertisements corresponding to these categories such as baseball tickets, sports jerseys, or newspaper subscriptions may be selected for display on xyz.com. In other embodiments, weights may be used to select ads in proportion to the categories. Continuing the previous example, the system may select two Sports and one News ad for xyz.com, roughly reflecting the 70% to 30% relative weightings. This process can also be applied to different sections of a website, individual pages on a website, a group of related websites, or any other grouping of web pages. These websites can include sites owned or operated by the search provider as well as websites of partners, affiliates, and any other third parties.

The categorization process can further be used to categorize users. Uncategorized queries may be selected from a particular user's search history. These queries can be individually categorized using one of the present methods. The resulting sets of categories and weights from the plurality of queries can be used to select categories and weights to associate with the user. In some embodiments, the search results from multiple queries in the user's history can be combined before choosing categories and weights. In another embodiment, the selected search results may correspond to locations the user visited, rather than the entire universe of results responsive to the user's query.

Once categories and weights have been assigned to the user, an understanding of the user's interests may be leveraged. Content for the user can be selected based on these categories. For example, the user categories can be used to tailor organic or sponsored search results to each user's interests. They can be used to select ads to display to each user on the search provider or another website. News stories on the user's home page can be chosen with respect to his associated categories and weights. Numerous other informational and marketing opportunities for the user are contemplated as understood by those skilled in the art.

In another embodiment, the categorization process can be used to improve relevancy while protecting user privacy. The search provider may only store search queries performed by a user for a limited time or never store them at all. This may reflect a firm-wide policy by the provider to protect users' privacy, or it may result from a choice by individual users. Before deleting a query, however, the provider may use the categorization process to obtain categories and weights for that query. By virtue of its more general nature, this category data is much less sensitive than data on particular queries run by the user. The provider may store the category data for the user without compromising the user's privacy. The categories may be used to provide more relevant search results or ads to the user as described. Stored categories and weights may be updated as the user performs new queries, reflecting changes in the user's interests over time.

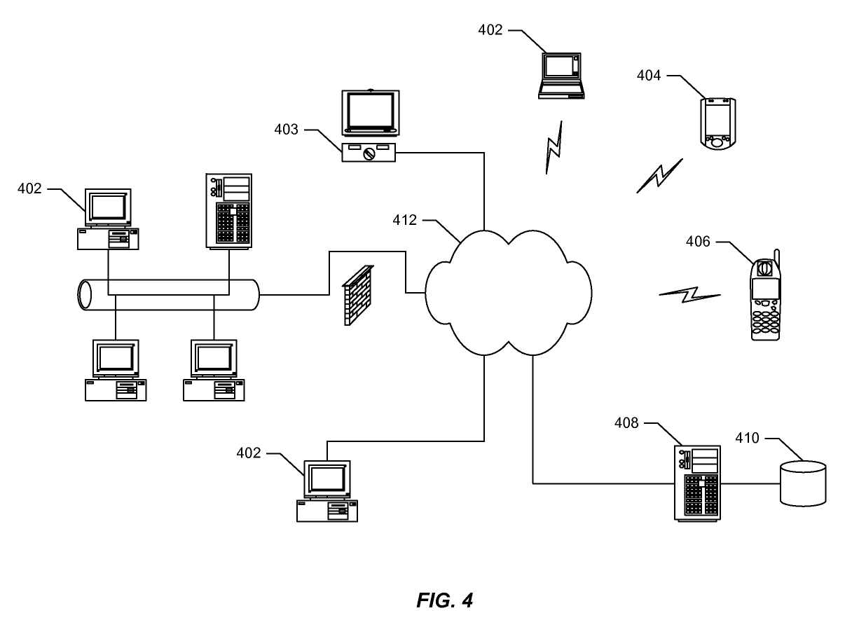

Embodiments of the present invention may be employed to associate categories with search queries, websites, or users in any of a wide variety of computing contexts. For example, as illustrated in FIG. 4, implementations are contemplated in which the relevant population of users interact with a diverse network environment via any type of computer (e.g., desktop, laptop, tablet, etc.) 402, media computing platforms 403 (e.g., cable and satellite set top boxes and digital video recorders), handheld computing devices (e.g., PDAs) 404, cell phones 406, or any other type of computing or communication platform.

According to various embodiments, search data processed in accordance with the invention may be collected using a wide variety of techniques. For example, search queries representing a user's interaction with a search engine or related service (e.g., a search history) may be collected using any of a variety of well known mechanisms for recording a user's online behavior. Search data may be mined directly or indirectly, or inferred from data sets associated with any network or communication system on the Internet. And notwithstanding these examples, it should be understood that such methods of data collection are merely exemplary and that search data may be collected in many ways.

Once collected, the search data may be processed in some centralized manner. This is represented in FIG. 4 by server 408 and data store 410 which, as will be understood, may correspond to multiple distributed devices and data stores. The invention may also be practiced in a wide variety of network environments including, for example, TCP/IP-based networks, telecommunications networks, wireless networks, etc. These networks, as well as the various search portals and communication systems from which search data may be aggregated according to the invention, are represented by network 412.

In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for categorizing search queries comprising:
obtaining first search queries with associated categories;
obtaining first search results responsive to the first search queries;
assigning each first search result a set of categories comprising the categories associated with the first search queries to which the first search result was responsive;
assigning a weight to each category in each set of categories based on a frequency with which the corresponding first search result appeared in response to the first search queries;
obtaining second search results responsive to one or more second search queries;
associating one or more categories with the second search queries with reference to the categories and weights assigned to the first search results included among the second search results.

2. The method of claim 1, wherein each search result is selected from the group consisting of (i) a URL, (ii) a domain portion of a URL, (iii) a host portion of a URL, (iv) a host and path portion of a URL, (v) a set of key terms associated with a URL, and (vi) metadata associated with a URL.

3. The method of claim 1, further comprising generating third search results in response to receiving the one or more second search queries from a remote device, wherein the third search results are selected with reference to the categories associated with the one or more second search queries, and transmitting the third search results to the remote device for display.

4. The method of claim 3, wherein the third search results comprise one or both of organic search results or sponsored search results.

5. The method of claim 1, further comprising selecting advertisements in response to receiving the one or more second queries from a remote device with reference to the categories associated with the one or more second queries, and transmitting the advertisements to the remote device for display.

6. The method of claim 1, wherein the second search queries comprise a history of search queries performed for a user, and further comprising associating one or more categories with the user with reference to the categories associated with the one or more second search queries.

7. The method of claim 1, further comprising selecting advertisements to display on a website based on the categories and weights assigned to the website located among the first search results.

8. A system for assigning categories to search queries comprising one or more computing devices configured to:
obtain first search queries with associated categories;
obtain first search results responsive to the first search queries;
assign each first search result a set of categories comprising the categories associated with the first search queries to which the search result was responsive;
assign a weight to each category in each set of categories based on a frequency with which the corresponding first search result appeared in response to the first search queries;
obtain second search results responsive to one or more second search queries;
associate one or more categories with the second search queries with reference to the categories and weights assigned to the first search results found among the second search results.

9. The system of claim 8, wherein each search result is selected from the group consisting of (i) a URL, (ii) a domain portion of a URL, (iii) a host portion of a URL, (iv) a host and path portion of a URL, (v) a set of key terms associated with a URL, and (vi) metadata associated with a URL.

10. The system of claim 8, wherein the one or more computing devices are further configured to generate third search results in response to receiving the one or more second search queries from a remote device, wherein the third search results are selected with reference to the categories associated with the one or more second search queries, and transmit the third search results to the remote device for display.

11. The system of claim 10, wherein the third search results comprise sponsored search results.

12. The system of claim 8, wherein the one or more computing devices are further configured to select advertisements in response to receiving the one or more second queries from a remote device with reference to the categories associated with the one or more second queries, and transmit the advertisements to the remote device for display.

13. The system of claim 8, wherein the second search queries comprise a history of search queries performed for a user, and wherein the one or more computing devices are further configured to associate one or more categories with the user with reference to the categories associated with the one or more second search queries.

14. The system of claim 8, further configured to select advertisements to display on a website based on the categories and weights assigned to the website located among the first search results.

15. A computer program product for categorizing search queries, comprising at least one computer-readable medium having computer instructions stored therein which are operable to cause a computer device to:
obtain first search queries with associated categories;
obtain first search results responsive to the first search queries;
assign each first search result a set of categories comprising the categories associated with the first search queries to which the search result was responsive;
assign a weight to each category in each set of categories based on a frequency with which the corresponding first search result appeared in response to the first search queries;
obtain second search results responsive to one or more second search queries;
associate one or more categories with the second search queries with reference to the categories and weights assigned to the first search results found among the second search results.

16. The computer program product of claim 15, wherein each search result is selected from the group consisting of (i) a URL, (ii) a domain portion of a URL, (iii) a host portion of a URL, (iv) a host and path portion of a URL, (v) a set of key terms associated with a URL, and (vi) metadata associated with a URL.

17. The computer program product of claim 15, wherein the one or more computing devices are further configured to generate third search results in response to receiving the one or more second search queries from a remote device, wherein the third search results are selected with reference to the categories associated with the one or more second search queries, and transmit the third search results to the remote device for display.

18. The computer program product of claim 17, wherein the third search results comprise sponsored search results.

19. The computer program product of claim 15, wherein the one or more computing devices are further configured to select advertisements in response to receiving the one or more second queries from a remote device with reference to the categories associated with the one or more second queries, and transmit the advertisements to the remote device for display.

20. The computer program product of claim 15, wherein the second search queries comprise a history of search queries performed for a user, and wherein the one or more computing devices are further configured to associate one or more categories with the user with reference to the categories associated with the one or more second search queries.

21. The computer program product of claim 15, further configured to select advertisements to display on a website based on the categories and weights assigned to the website located among the first search results.
